(19) United States
(12) Patent Application Publication
(10) Pub. No.: US 2001/0034676 A1
(43) Pub. Date: Oct. 25, 2001

(54) Method of payroll access

(76) Inventor: Stevan P. Vasic, Sandy, UT (US)

Correspondence Address: KIRTON & McCONKIE, 1800 Eagle Gate Tower, 60 East South Temple Street, P. O. Box 45120, Salt Lake City, UT, 84145-0120, US

(21) Appl. No.: 09/782,756

(22) Filed: Feb. 13, 2001

Related U.S. Application Data
(60) Provisional application No. 60/182,420, filed on Feb. 14, 2000.

(51) Int. Cl. G06F 17/60

(52) U.S. Cl. 705/30

(57) ABSTRACT

The present invention provides a payroll access program allowing an employee to request access to payroll through a third party. The third party receives the request from an employee for payroll access and then forwards requested funds to the employee on demand. The third party then notifies the payroll service handling the employee's payroll to deduct the forwarded funds from the employee's payroll check and reimburse the third party for the funds forwarded. The third party and the payroll service may also deduct and receive a fee for the service.

### RELATED APPLICATION

This application claims priority under 35 U.S.C. § 119(e) to Provisional Patent Application Ser. No. 60/182,420, filed Feb. 14, 2000, for “METHOD OF PAYROLL ADVANCE” which is incorporated herein by reference for all purposes.

### BACKGROUND

1. The Field of the Invention

The present invention relates to a method for accessing payroll. More specifically, the present invention relates to a method for allowing employees to receive payroll and to access payroll on demand, even in advance.

2. Background

Distributing employee pay through a payroll system is a practical necessity for many employers. Typically, employers hire individuals or retain a payroll service to administer the payroll. While the regular periodic disbursement of income through a payroll service or payroll administrator facilitates the payroll process, the timing of employees' need for income does not always coincide with the disbursement of payroll. In this regard, employees must sometimes ask their employers for access to their presently earned (but not yet paid) or future wages in order to meet financial needs which arise before pay day. Making such a request can be awkward and embarrassing. If an employer rejects an employee's request, the employee is faced with unpleasant options. Lacking the necessary finances, the employee may have to suffer some hardship or turn to third party lenders who are unknown to the employee. Short term loans from third party lenders can take a great deal of time and energy to arrange, can be very expensive, and can expose the employee to potential fraud.

If an employer grants an employee's request for early access to his wages, then the employer and employee must go through accounting and administrative procedures that cost the employer time and money and create cash flow problems for the employer. Some of these procedures can greatly complicate payroll administration. The employer may have to cut a special check for the employee, keep separate track of the amounts of various payroll withdrawals, taxes, and deductions, and/or notify the payroll service of the changes. Likewise, the payroll service of the employer also spends time and money to balance the employee's account and deduct the appropriate amount. It would be advantageous to develop a payroll access program that allows employees to have early and easy access to payroll funds without going through such administrative procedures.

Another problem with prior art methods for requesting early payroll access is that the process of requesting and obtaining access to the payroll advance often requires a number of individuals and sometimes third parties to perform additional work beyond normal payroll administration. This additional work generally goes uncompensated. Therefore, every payroll access request and subsequent payroll access will cost the employer and the payroll service time and money to process. This uncompensated effort adds to the tension created when an employee requests access to his payroll.

In the past, payroll or paydays have been set days or dates determined by the employer. While it is true there have been employers willing to loan an employee funds against future wages or pay before the set paydays, doing so often causes problems for the employer.

It would be advantageous to provide a method for accessing payroll as the employee needs it, when and where the employee wants or needs the money and to further give the employee the ability to access his pay or set his own paydays for wages that he has already earned, or to borrow against pay or wages that he will earn, as he needs the money. Such a method is disclosed and claimed herein.

### BRIEF SUMMARY AND OBJECTS OF THE INVENTION

It is an object of one embodiment of the present invention to provide payroll access on demand.

It is another object of one embodiment of the present invention to reduce the administrative difficulties the employer faces in permitting an employee to access pay.

It is yet another object of at least one embodiment of the present invention to provide an automated teller machine card that replaces an employee's paycheck.

It is still another object of at least one embodiment of the present invention to provide a payroll access program in which the employer himself is not required to fund an employee's payroll access and which does not create cash flow problems for the employer.

It is a further object of at least one embodiment of the present invention to compensate the parties who facilitate an employee's payroll access.

It is yet a further object of at least one embodiment of the present invention to facilitate requesting an employee's payroll access.

It is still further an object of at least one embodiment of the present invention to provide payroll access that allows for but does not require the cashing of a check.

It is moreover another object of at least one embodiment of the present invention to provide payroll access for an employee who does not have a bank checking, savings, or similar account.

It is an additional object of at least one embodiment of the present invention to provide an employee cash or credit for his wages that is later deducted from the employee's paycheck.

It is yet an addtional object of one embodiment of the present invention to allow an employee access to wages and pay already earned.

It is still an additional object of one embodiment of the present invention to allow an employee access to pay before the designated pay day.

It is further an additional object of one embodiment of the present invention to allow an employee to select his own payday.

Additional objects and advantages of the invention will be understood from the following description or may be learned by the practice of the present invention. The objects and advantages of the present invention may be realized and obtained by means of the methods particularly pointed out in the appended claims.

To achieve the foregoing objects, and in accordance with the present invention as embodied and broadly described herein, the present invention provides a payroll access program for obtaining payroll access on demand. The present invention may, in one presently preferred embodiment, be summarized as a payroll access program providing a means for a third party to receive a request from an employee for payroll access, forwarding the requested funds to the employee on demand, and deducting the forwarded funds from the employee's payroll check. The employee may access the money he needs based upon some limit, such as a limit based upon what has already been earned, or based upon probable future earnings for a given pay period.

The third party who receives the request for payroll access is preferably a party who is not the employer of the employee, though the employer could receive the request. The third party could be a payroll service, a credit company, a payroll advance company, or similar organization. The third party is authorized to request and/or to make deductions from the payroll check of the employee. The employee can make the request for the payroll access to the third party directly or indirectly. In one presently preferred embodiment, an employee may request the payroll access through the use of a special Automated Teller Machine (“ATM”) card. Likewise, the transfer of the funds to the employee can occur in any number of ways. For example, in one presently preferred embodiment, the funds may be paid in cash through an ATM machine or by extending a line of credit to the employee. In addition, the funds may be paid or transferred to the employee all at once or over a period of time, as requested by the employee. Similarly, the funds deducted from the employee's paycheck to cover the previously accessed wages may be taken out of the employee's check all at once, or over a period of time and may be deducted by means known in the art.

Payroll access can be provided to an employee on demand and subsequently deducted from the employee's payroll check. This can be done, for example, by a payroll service, a bank, a payroll advance company, and/or some other third party. One presently preferred method for providing payroll access on demand comprises the steps of providing a payroll access resource of a payroll access service or other party from which account funds tied to payroll can be withdrawn by employees; providing access to the payroll access resource to an employee of the employer; transferring funds from the payroll access resource into the control of the employee when requested by the employee; transferring information regarding the request for access to the provider of the payroll access resource and/or to the payroll service, deducting from the employee's pay an amount equal to the wages forwarded (or alternatively, over time, amounts equaling the wages forwarded) plus a transaction fee to yield an adjusted pay; and distributing the adjusted pay to the employee and the transaction fee to the party or parties entitled to the transaction fee.

In some circumstances, it may be preferable to provide a principal payroll access resource, such as a master account, and a secondary payroll access resource such as a sub-account of the master account. The payroll access company (or some other third party) can keep a large master account with funds sufficient to cover payroll access for numerous employees and have separate “sub accounts” for individual employees that remain empty and inactive until an employee requests access. Having a master account and sub-account that are activated only upon a request for access to wages saves unnecessary administration. Rather than funding numerous individual accounts that may only potentially be accessed for each employee in the payroll access program, the payroll access company maintains the payroll access funds in a principal payroll access resource (e.g., master account) and later divvies out the funds into secondary payroll access resources (e.g., sub-accounts) to which the employee has access. Thus, upon an employee's request of access to payroll wages, funds can be transferred from the master account into a sub-account from which the employee draws his or her forwarded wages.

In one presently preferred embodiment, access to the payroll access resource is provided to the employee “on demand.” Providing access “on demand” preferably includes providing a participating employee with the means to request and to receive advance payroll without requiring any authorization for that specific request from the employer or any third party. In other words, once an employee is participating in a payroll access program, it is not necessary for the employee to seek permission or authorization to receive forwarded wages from payroll. Thus, for example, the payroll may be accessed “on demand” by being approved at an ATM through an ATM computer network or by some other means.

If desired, in one presently preferred embodiment, the amount of funds accessible to the employee may be limited to a predetermined amount. The amount to which the employee is limited may be based, for example, upon a number of factors, such as the amount of the employee's normal paycheck, the relative risk of loss or non-payment, the amount of the transaction fee, the employee's financial history or employment history at the time of the request, the number of days worked for a given pay period and other relevant factors.

In one presently preferred embodiment, the transaction fee may be or include a percentage of the amount requested, an annual membership fee, a flat fee for providing the service to the employee, such as a monthly payment for the service, or may be based upon each individual request or a number of requests per month or per pay period. In this regard, the employee could prepay for a certain number of payroll access transactions. The process by which the money is transferred may also require a fee such as a money wiring fee or similar transaction cost. Such transaction fees preferably, though not necessarily, may be deducted from the pay check as well. The fees for the transaction could alternatively be collected in other ways, for example, billing the employee at a later date, charging an up-front fee to participate which the employee pays before being eligible for advances, deducting fees from an employee's account or other ways.

### BRIEF DESCRIPTION OF THE DRAWINGS

The foregoing and other objects and features of the present invention will become more fully apparent from the following description and appended claims, taken in conjunction with the accompanying drawings, in which:

FIG. 1 shows a flow chart of one presently preferred embodiment of the present invention in which an employee gains on-demand payroll access through a payroll access company using a third party bank;

FIG. 2 shows a flow chart of one presently preferred embodiment of the present invention in which an employee gains on-demand payroll access through a payroll access company that supplies its own funds for the access;

FIG. 3 shows a flow chart of one presently preferred embodiment of the present invention by which an employee accesses payroll, wherein a credit card company serves as a payroll access company;

FIG. 4 shows a flow chart of another presently preferred embodiment of the present invention by which an employee gains payroll access;

FIG. 5 shows a flow chart of still another presently preferred embodiment of the present invention;

FIG. 6 shows a flow chart of yet another presently preferred embodiment of the present invention; and

FIG. 7 shows a flow chart of payroll access where a wire transfer company supplies funds for the access.

### DETAILED DESCRIPTION OF PREFERRED EMBODIMENTS

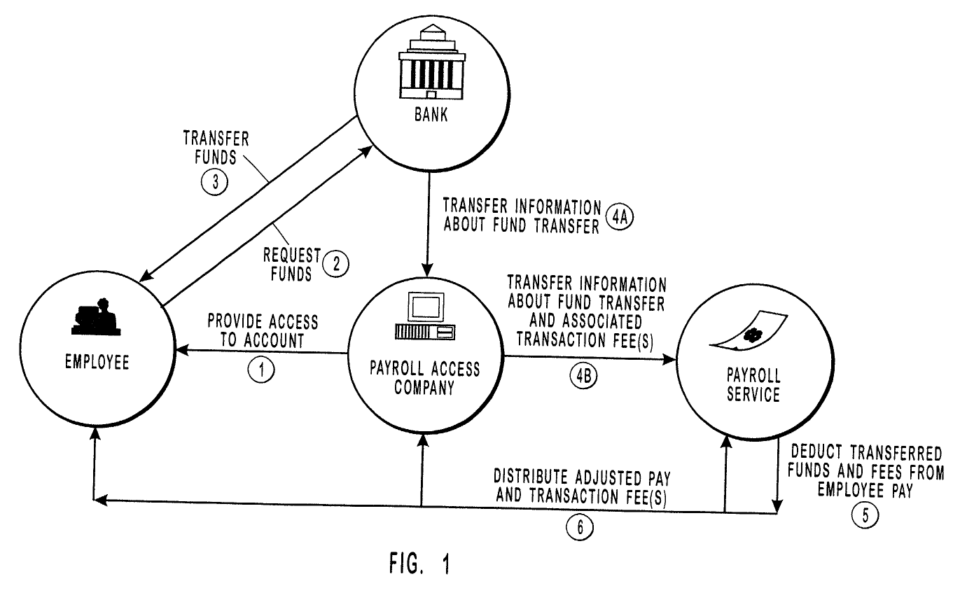

It will be understood that the components of the presently preferred embodiments of the present invention, as generally described and illustrated in the figures herein, could be arranged and designed in a wide variety of different configurations. Thus, the following more detailed description of the presently preferred embodiments of the systems and methods of the present invention, as represented in FIGS. 1 through 7, is not intended to limit the scope of the invention, as claimed, but is merely representative of the presently preferred embodiments of the invention.

The first step of providing a payroll access resource can be accomplished in any number of ways or combination of ways that provide an employee with financial resources from which forwarded wages may be drawn. For example, providing a payroll access resource may be accomplished by providing a third party bank account. The third party may be a payroll access company, which facilitates and regulates the payroll access. Alternatively, the payroll access company may have an account in a third party bank, from which the employees participating in the payroll access program may draw. Similarly, the payroll access company may have sufficient funds on hand from which the employees may draw directly. The payroll access resource may be a bank account belonging to the payroll service that handles the employee's check, funds of the payroll service, or funds from an account of the employer or even the employee. A line of credit through a credit card company may also serve as a payroll access resource.

The step of providing access to the payroll access resource may be accomplished by a variety of means. For example, access may be provided to an employee by a predetermined system of requesting access to the payroll access resource. An employee may request access to the payroll access resource in person, such as at the office or branch of a third party providing the payroll access resource. Requests may be made in writing or through telecommunications means such as telephone, automated phone system, facsimile, or via the internet. Automated requests may be made, such as through an automated teller machine using a payroll access card. The payroll access card may be tied to a line of credit, or may be drawn from the accounts of the payroll service. Likewise, requests and transfers of funds may be made by wire to the employee, the payroll access resource, or the ATM card account. The wire service may charge a wire transfer fee for wiring the funds to the employee or to the payroll access resource.

This step of transferring the forwarded wages can be done in several ways. The wages may be paid to the employee in person, in cash, or by check. The funds may come in the form of a direct deposit to various accounts upon which the employee can draw. The funds can be delivered electronically or via the internet, or the money may be wired or otherwise electronically transferred to the employee. The funds may be transferred into an account to which the employee has a line of credit based on the payroll access program or credited to another existing line of credit. Likewise, the money can be mailed to the employee.

The optional step of transferring the information regarding the transaction can be accomplished manually, but is preferably accomplished automatically and electronically. Information regarding the amount of the funds forwarded and can be electronically and automatically sent to the appropriate party. Where the money is being drawn from a third party bank, the bank will be notified of the draw and will subsequently notify the payroll access company and/or the payroll service. It is also contemplated that in the process of notification, an automated system for calculating transaction fees will determine the appropriate transaction and other fees for the payroll access and notify the payroll service of the transaction fees.

The step of deducting the forwarded funds and the transaction fee to yield the adjusted pay is accomplished by the employer, the payroll service, or some other third party, who, along with deductions required for tax and other purposes, will deduct the amount of the forwarded funds and the appropriate transaction fee from the employee's check. The amount deducted should appear on the pay stub or an equivalent report issued with the employee's pay so that the employee will know the source and the amount of payroll access deduction and transaction fee. The amount of forwarded funds may be deducted from the wages of a single pay period or over a period of time.

The optional step of distributing the adjusted pay can occur in any suitable fashion for transferring the funds, such as distribution of cash, check or electronic deposit. The transaction fee may be transferred to the payroll advance company electronically or otherwise as likewise the employee's salary and receipt can be delivered electronically or otherwise.

In one embodiment, the employee makes a request to a third party for payroll access. In this embodiment, the third party is the payroll service that administers the employee's periodic paycheck. Thus, the payroll service is authorized to make deductions from the employee's check. The payroll service forwards the requested money to the employee and subsequently deducts from the employee's paycheck an amount equal to the forwarded funds. The payroll service may also charge a transaction fee or similar fee for providing the service. Because the employee is participating in the payroll access program, the employee is not required to seek authorization from the employee's employer to access payroll.

In a preferred embodiment, the means for providing the access is an ATM card. An employee requests the transfer of funds using the ATM card from the funds for the advance or transfer to the employee. Using an ATM, information regarding the payroll access can be automatically and electronically forwarded to the employer and notice of the required deduction from the employee's paycheck is automatically an electronically forwarded to the payroll service.

The employee may make the request for the payroll access on demand from numerous convenient locations by using an ATM-type card issued to the employee by the employer, the bank, the payroll service, or some other third party. The employee inserts the card into an ATM and thereby gains access to funds from the payroll. The employee receives forwarded wages, limited to an appropriate amount for the employee.

Alternatively, the payroll service could receive the request from the employee in writing or in person or in some other form and could send a check to the employee or deposit the funds directly into an employee's bank account.

Regardless of the ways in which the request and subsequent transfer of funds are carried out, the information regarding the payroll access transaction is made available to the payroll service, which then makes an appropriate deduction from the employee's periodic paycheck. The payroll service and the employer may also charge a fee for the use of the service or for participating in the payroll access program. The fee may likewise be deducted from the employee's check. If the employer is not using a payroll service and is handling payroll internally, the employer may directly deduct the amount from the paycheck.

In another embodiment of the present invention, an employee participating in a payroll access program receives an ATM card or some form of electronic cash, which gives the employee limited access to an account, such as a bank account funded by a payroll access company and tied to the employee's payroll account. The employee uses the ATM card to draw a limited dollar amount from the account through a bank's ATM. The bank may be the employer's bank, the employee's bank, or some other third party bank. The dollar amount may be limited by the particular payroll access program in which the employee participates. The third party bank delivers the money through the ATM to the employee. The bank then notifies the payroll access company of the payroll transaction. The bank, or alternatively the payroll access company, then informs the payroll service that funds have been forwarded against the employee's pay and that a corresponding amount plus a transaction fee should be deducted from the employee's standard payroll amount. The payroll company then distributes to the employee the standard pay minus the forwarded funds and the transaction fee and the payroll service distributes to the payroll access company the amount forwarded and the transaction fee. The payroll service and other parties that facilitate the transaction may also charge and deduct additional transaction fees that are paid by the employee directly or through the payroll access company.

The forwarded dollar amount may be limited in a number of ways appropriate for the given circumstances. Employees in different circumstances may qualify for different payroll access programs or different limitations within a program. The payroll access company, individually or with the employer and the payroll administrator, may decide which programs are appropriate for given employees. Payroll access limits may be based on a given percentage of the employee's pay. Factors such as the line of work, the length of time the employee has worked for the employer, the number of days worked in the pay period, the frequency and number of uses of the system in the past, and the employee's credit rating are all potential factors in determining a limit on the payroll access. Factors such as the credit risk to the payroll access company, the funds available in the payroll access resource, employee performance, and other factors may be considered.

In another embodiment of the present invention, the payroll access company provides a payroll access resource in the form of funds held within the payroll access company. The employee has access to the funds by making a formal request for payroll access. The request may be made in person, in writing, or electronically, or using one of the methods disclosed herein. The payroll access company transfers the funds to the employee and informs the payroll service of the transaction and the corresponding transaction fee. The payroll service deducts from the employee's pay the appropriate sum and subsequently distributes to the payroll access company and the employee the appropriate dollar amounts. Alternatively, the payroll access company may perform the duties of the payroll service and administer the payroll as well as operate the payroll access program.

In another embodiment of the present invention, the payroll access resource is a line of credit tied to the employee's payroll. The employee gains access to the payroll access resource by use of a credit card with a payroll access limit. The credit card may have an additional line of credit not tied to the payroll access program or may have a line of credit equal to the payroll access program limit. When the employee uses the credit card to access wages, the credit card company acting as a payroll access company, informs the payroll administrator of the transaction and the appropriate transaction fees. The credit card company forwards funds to the employee, such as in the form of activating or increasing a line of credit or a cash advance. The payroll service then deducts the appropriate amounts from the employee's pay and distributes the deducted amounts and the transaction fee to the credit company and others, as necessary. The remaining pay is distributed to the employee. In an alternative embodiment, the payroll service may act in conjunction with a credit company and issue a payroll card, a credit card, or a similar debit/ATM card.

In another embodiment, the payroll service may issue a payroll card in lieu of a standard pay check or other form of payment. The payroll card allows the employee to draw from the payroll service's account any amount up to and equal to the employee's pay for that period. The payroll card allows the employee access to substantially all his or her pay without having to take the pay check to the issuing bank to cash the check.

In yet another embodiment, employee information is given to a payroll service. The payroll service forwards the employee information to a payroll access company retained by the employer or the payroll service. The payroll access company gathers information on the employee(s), such as names, addresses, phone numbers, average period paychecks, time on the job, and social security numbers and determines an appropriate payroll access limit for each employee. The payroll access limit is tied to an ATM accessible account and the pertinent information regarding the employee's potential for ATM payroll access and the corresponding limit is forwarded to the bank. The bank (or alternatively some other party) issues a payroll access ATM card to the employee, which allows the employee access to the limited amount determined by the payroll access company, through an ATM.

Preferably, the payroll access company has established a master account at the bank issuing the ATM cards and has established a sub-account for each employee issued an ATM card. When the employee receives the ATM card with the pertinent information regarding remittance and how to obtain payroll access, the employee can use the ATM card at an ATM facility to contact the issuing bank through the electronic computer network. When the employee contacts the issuing bank, corresponding funds are automatically transferred from the master account into the employee's individual sub-account. Thus, the sub-account actually has no funds until the sub-account is activated by using the card and the funds are automatically transferred from the master account or alternatively transferred or wired with associated fees.

If the funds cannot be automatically transferred from a master account to a sub-account as described, the employee may notify the payroll access company prior to accessing payroll through the ATM card. For example, the employee may notify the payroll access company by placing a call to the payroll access company. The employee could also request the account be activated by internet, fax, or through the ATM. The payroll access company can automatically transfer the funds into an account that is linked to the employee's ATM card. Again, in this way, the funds are not actually placed in the ATM accessible account until the employee indicates his or her intent to use the card.

After the ATM machine notifies the issuing bank of the withdrawal and issues the funds to the employee, the bank notifies the payroll access company of the transaction. The payroll access company totals the amount and number of transactions plus appropriate fees and forwards that information to the participating payroll service and/or the employer. The payroll service and/or the employer can then deduct the total amount of funds forwarded (or alternatively made periodic deductions) including the fees from the paycheck of the employee. The payroll service forwards the deducted amount including appropriate fees to the payroll access company. The payroll access company notifies the bank that the employee's payroll access obligation has been satisfied. At this point, the bank can reset the limit of the payroll access ATM card for the next pay period and reset the accessability to payroll or leave the account idle, as appropriate. The payroll access company may send the payroll service and the employer a commission for the transaction in order to compensate them for their services and for using the payroll access company.

In another embodiment of the present invention, the payroll access card or a payroll card is issued to the employee. The employee uses the card to withdraw money from an ATM or charge purchases, up to the limit on the card. The employee may use the entire amount available on the card or may use only a portion of the amount available on the card. Preferably the amount of money charged against the card during a given pay period is deducted from the employee's next pay check so that all of the purchases and transactions made using the card are paid for with each pay period. However, it is also contemplated that a periodic payment could be deducted from the employee's paycheck and applied toward purchases and cash withdrawals made on the card.

In another preferred embodiment, the card acts as a form of cash and is charged with a certain dollar value and is used with various vendors or to obtain cash. The amount charged to the card is then deducted from the employee's pay check. The potential limit on the card may equal the dollar amount that will be deducted from the employee's check minus any fees or payments that will also be deducted. Alternatively, a pre-charged loading fee could be assessed. The payroll card may also be tied to a line of credit. All of the funds may be distributed for the employee's check or the payroll card may have a carry over balance.

In another embodiment of the present invention, the present invention is used by the employer without an outside partner or third party. The employer implements the payroll access program for employees to access payroll on demand, without the employer having to authorize or otherwise administer individual payroll access for the employees. Using the present invention, the employee is able to automatically receive a request for forwarded wages and the employer can automatically deduct the funds and charge a fee, if desired. In this embodiment of the present invention, the employer establishes a payroll access resource and provides the employee access to the payroll access resource.

As explained above, the party facilitating the request and transfer is preferably not the employer of the employee, though it is understood that the employer working together with an outside partner could practice the present invention to the advantage of both employer and employees. For example, an outside partner could set up and facilitate the implementation and administration of the payroll access program in a way that allows the employer to provide payroll access through the payroll access program of the present invention. In one embodiment of the present invention, an outside partner provides funds, technical means, and instruction to the employer that allows the employer to implement the payroll access program. The employer may draw from the outside partner's funds to provide a payroll access resource for employees. In this way, the employer is involved in the payroll access process but is not required to go through the work of authorizing individual requests for payroll access.

Regarding the several embodiments and descriptions of the present invention as set forth above, in order to effectively use the present invention, it is contemplated that a user will assemble combinations of the various specific means disclosed, such as the various means for requesting the access, means for providing access to a payroll access resource for means for transferring funds, means for transferring information related to the payroll access transaction, a means for deducting the funds, and transaction fees from the employee's check and/or means for distributing the paycheck and fees. Likewise, it is contemplated that the one or more parties may carry out or facilitate any one or a combination of the steps of the present invention, such as the steps of providing a payroll access resource, providing access to the payroll access resource, transferring the funds, transferring the information necessary to parties involved in the transaction, deducting the funds, and distributing the adjusted pay and transaction fees.

In the present invention, employees who access payroll may be charged a set fee or an access fee. There may also be a fee for using an ATM card. Typically, the ATM card is tied to some monetary limits, such as salary earned based on actual hours worked to date for the pay period, the employee has access to salary or pay as he or she desires. This employee could access payroll daily, weekly, bi-weekly, etc. On the day when the employee would otherwise receive a paycheck or pay stub, the employee receives a settlement, stub, or pay showing the amounts of pay already accessed along with the check or other payment he would normally receive.

For example, John Smith works 16 hours. In two days at $10 per hour, he has approximately $160 in gross wages. He is allowed to access up to seventy-five percent of that amount using the present invention, or $120. A week later he has 40 hours total work for the pay period, and having accessed 16 hours of previous pay, he has 24 hours of pay available, of which he can access seventy-five percent. Again, that money can be accessed as needed on a daily or weekly basis.

In one embodiment, the hours worked by an employee and the correlating daily wages earned are tracked and stored electronically. Information is updated daily giving a running total of the employee's wages earned for a given pay period. This information is included in the payroll access system of the present invention. The information can be utilized by the parties involved in setting limits on withdrawals from the payroll, such as allowing a payroll access withdrawal based on the hours worked to date or may be used by the employee to evaluate how much of his or her payroll he wishes to access. An employee could view their earned wages and/or hours and the corresponding dollar amounts over the internet via a secure internet portal. The employee could also view the payroll history at the website and could print from the website pay stubs or reconciliation of payroll taxes, advances, garnishments, and other payroll related transactions.

The website and materials available on the website could also serve as proof of income and could be used for loans, credit card companies, or other situations in which there is a need to verify income. The internet portal may be accessed at various levels. One level of access may be granted to the employee giving complete access to all data and the ability to conduct transactions. A more limited access might be given to companies that need to verify income. A third type of access could allow certain types of transactions to take place over the internet portal by authorized users other than the employee.

FIG. 1 shows a preferred embodiment of the present invention in which a payroll access company establishes an account for an employee and provides access to the account. The access can be provided by establishing an account at a bank and allowing the employee to use the bank's services to access the account. The payroll access company funds the account so that there is a sufficient amount of money from which the employee can draw funds. The employee makes a request for funds from the bank and the bank transfers the funds to the employee. The bank then notifies the payroll access company of the amount withdrawn from the account. The payroll access company in turn notifies the payroll service handling the employee's payroll that the amount of money transferred to the employee through the account, plus any associated transaction fees, should be deducted from the employee's check. The payrolls service then deducts the amount of money transferred and the corresponding fees form the employee's pay, distributes the adjusted pay to the employee and distributes the transaction fees to the payroll access company, the bank, and any other entities requiring a transaction fee. The payroll service may elect to deduct a transaction fee as well.

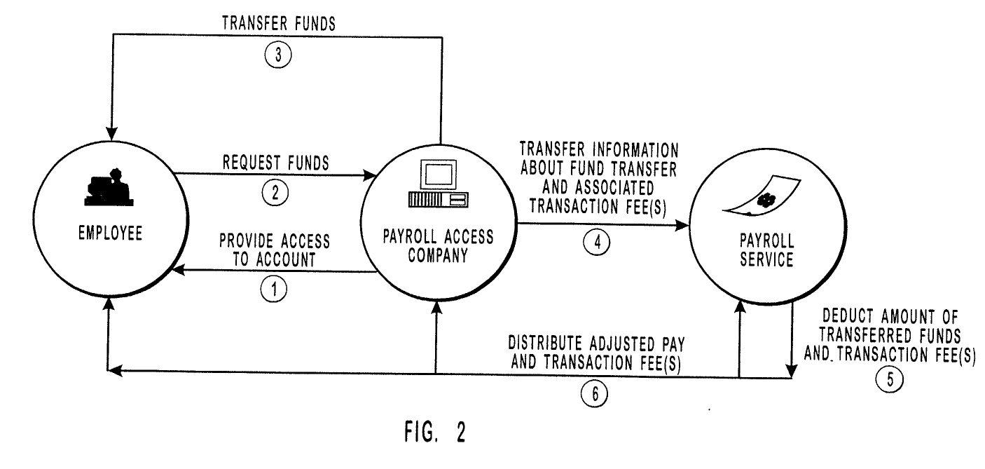

FIG. 2 shows another embodiment of the present invention in which a payroll access company provides access to funds to the employee directly. Thus, an employee can make a request directly to the payroll access company and the payroll access company can transfer the funds to the employee. The payroll access company then notifies the payroll service of the funds that have been forwarded to the employee and the payroll service will subsequently deduct the amount of money transferred to the employee plus additional transaction fees from the employee's paycheck. At payday the payroll service will distribute the adjusted pay to the employee and distribute the associated transaction fees. The payroll service may elect to distribute the paycheck and the transaction fees during separate distributions.

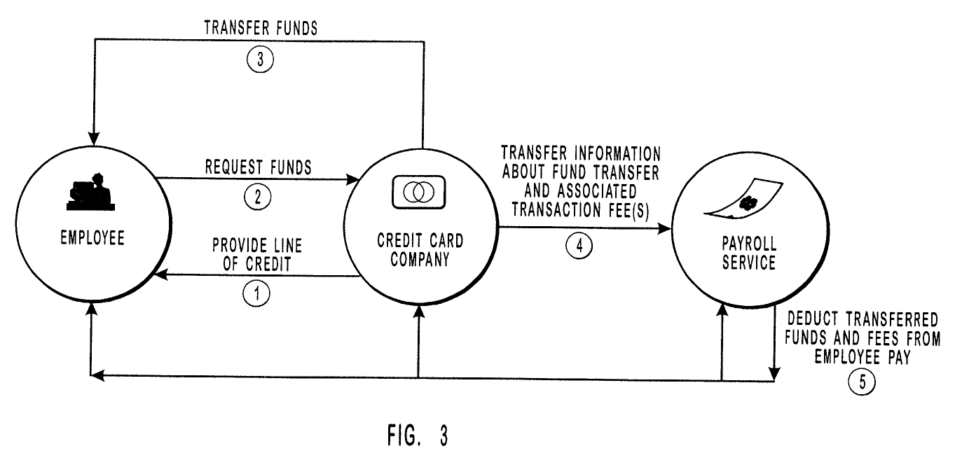

FIG. 3 illustrates another embodiment of the present invention. In this embodiment, a credit card acts as the source for the employee's payroll access. The credit card company provides the employee with a line of credit tied to the employee's payroll. Using a credit card or other services provided by the credit card company, the employee can request access to payroll funds and the credit card company will transfer the requested funds to the employee. After making the transfer, the credit card company can then inform the payroll service of the amount forwarded to the employee and related transaction fees. The payroll service then can distribute the adjusted pay and transaction fees to the employee and credit card company, respectively.

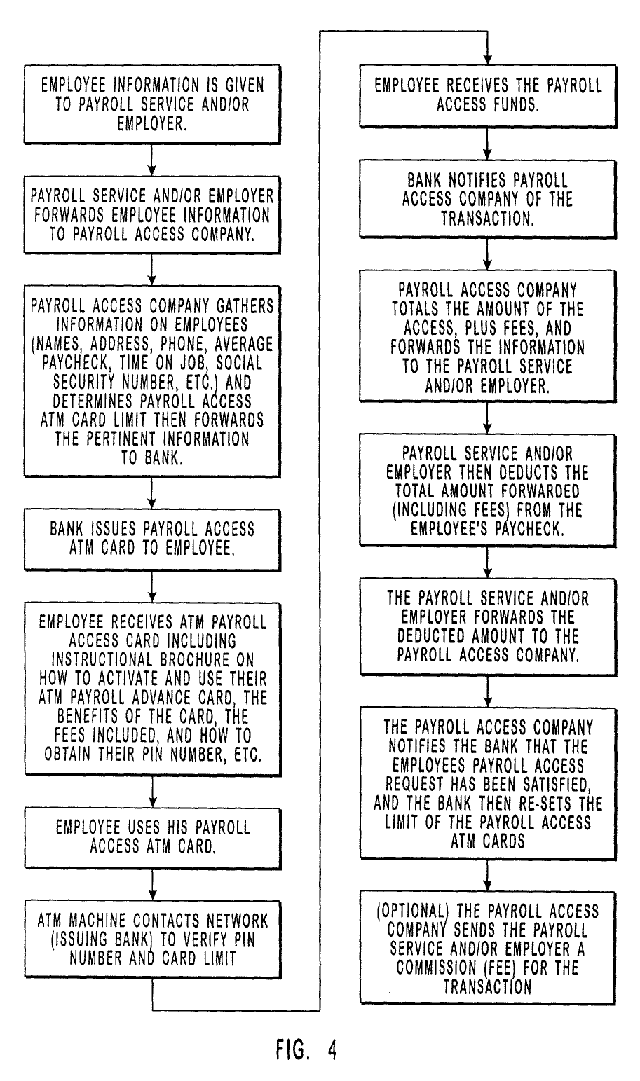

FIG. 4 shows a flow chart of one embodiment of the present invention in which an employee uses a payroll access ATM card to access payroll.

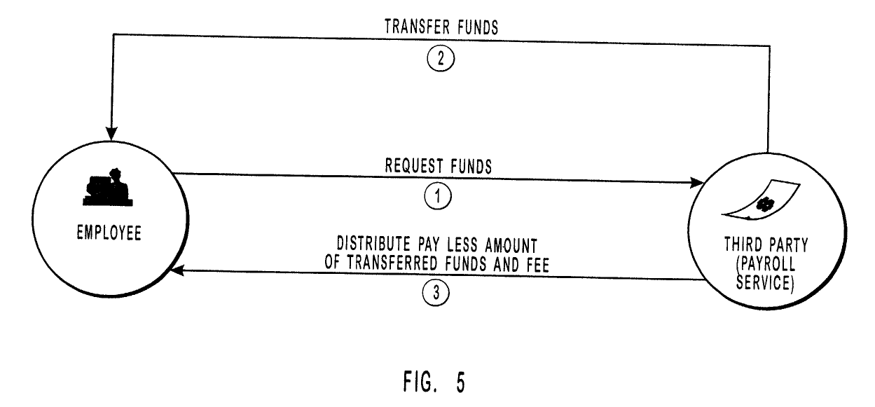

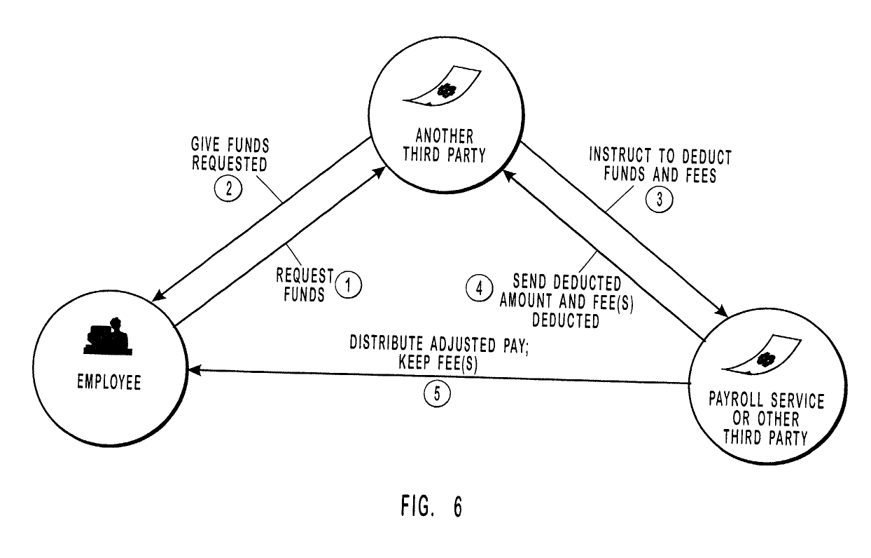

Access to the payroll can be provided by the payroll service company itself as indicated in FIGS. 5 and 6. In FIG. 5, the payroll service company or some other payroll related company can provide the employee with access to payroll. As with other embodiments, the employee submits a request to the payroll service company and the payroll service company forwards the funds to the employee. The payroll service company then distributes the employee's adjusted pay minus the forwarded funds and any appropriate transaction fees.

FIG. 6, yet another embodiment of the present invention, illustrates that potentially any third party can act as an intermediary to allow the employee to request funds and to forward funds to the employee based on an operating relationship with the employee's payroll service company or some related third party having control over the employee's payroll.

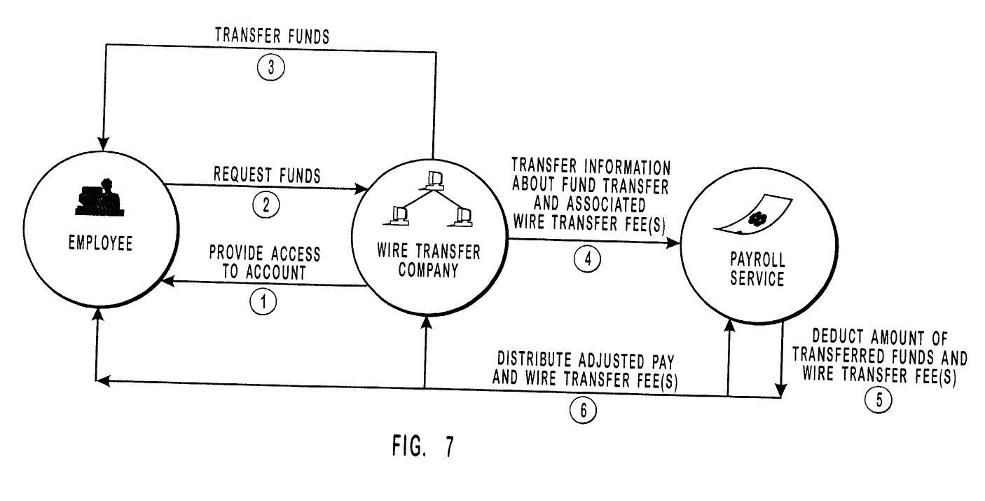

FIG. 7 shows another embodiment of the present invention whereby an employee requests access to an amount of payroll from a wire transfer company. The request may come over the internet or through an ATM or any of the other means for requesting such access mentioned above. The wire transfer organization provides access to payroll funds by receiving electronic requests for such funds from a variety of sources. The employee can request funds from payroll to be wired to an account or location of the employee's choice. Having received the employee's request, the wire transfer company then transfers the requested amount of money and notifies the employee that the amount forwarded plus any transaction costs and wire transfer fees will be deducted from the employee's payroll. The wire transfer company notifies the payroll service of the amount forwarded and appropriate transaction fees. The payroll service deducts an amount equal to the funds forwarded plus the access transaction fees from the employee's periodic paycheck. The payroll service can then forward the transaction fee, such as the wire transfer fee to the wire transfer company, as well as forwarding any other fees out of the employee's paycheck and distribute the adjusted pay to the employee on the employee's regular pay day. The payroll service may also choose to charge a transaction fee.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within that meaning and range of equivalency of the claims are to be embraced within their scope.

What is claimed is:

1. A method of payroll access comprising:
receiving a request from an employee for access to the employee's payroll, forwarding funds to the employee on demand; and
deducting the forwarded funds from the employee's payroll check.

2. The method of claim 1, wherein the employee uses an automatic teller machine to request and receive the funds.

3. The method of claim 1, wherein the employee can access wages and pay already earned but not paid for a pay period.

4. The method of claim 1, wherein the employee can access wages and pay not yet earned.

5. The method of claim 1, wherein the employee can access payroll prior to an employer's designated payday.

6. The method of claim 1, wherein the employee's request for payroll access is transmitted via the internet.

7. The method of claim 1, wherein the employee's request for payroll access is transmitted via facsimile.

8. The method of claim 1, wherein the employee's request for payroll access is transmitted via E-mail.

9. The method of claim 1, wherein the employee's request for payroll access is transmitted via telephone.

10. The method of claim 1, wherein said request is authenticated using an authentication means selected from the group consisting of: personal identification number, biometric identification, a password, an electronic key, a signature verification, and photo identification.

11. The method of claim 1, wherein the funds are forwarded to the employee all at once.

12. The method of claim 1, wherein the funds are transferred to the employee through disbursements over a period of time.

13. The method of claim 1, wherein the amount deducted from the employee's payroll is deducted from the employee's wages from a single pay period.

14. The method of claim 1, wherein the amount deducted from the employee's payroll is deducted through several deductions over a period of time.

15. The method of claim 1, wherein the employee can access wages not yet earned for a current pay period.

16. The method of claim 1, wherein the payroll access is provided through a payroll access resource.

17. The method of claim 16, wherein the payroll access resource is a financial resource selected from the group consisting of: a bank account, a credit account, a secondary payroll access account, a shared account, a trust account, a temporary account, a savings account, and a checking account.

18. The method of claim 16, wherein the payroll access account is an account holding party selected from the group consisting of: the employee, the employer, the payroll service, a payroll advance company, a wire transfer company, a bank, a credit union, a third party financial institution, and a credit card company.

19. The method of claim 1, wherein the funds are forwarded to the employee by a transfer means selected from the group consisting of: electronic transfer, certified check, automated teller machine, wire transfer, extended credit, pre-charged payroll card, and electronic credits.

20. The method of claim 1, wherein the funds made accessible are limited to a predetermined amount.

21. The method of claim 1, wherein the amount deducted form the employee's payroll includes a transaction fee

22. The method of claim 1, wherein the employee pays for a predetermined number of payroll access transactions.

23. A method of payroll access comprising:
receiving an electronic request from an employee for access to the employee's payroll, wherein said request originates from an automated teller machine and is transmitted over a computer network, electronically authorizing a distribution of funds according to said request;
distributing the funds through the automated teller machine; and
deducting the amount of the distributed funds and a fee from a paycheck of the employee.

24. The method of claim 23, wherein payroll access is provided on demand.

25. The method of claim 23, wherein payroll access is provided by means of an automatic teller machine card.

26. The method of claim 23, wherein the employee can access wages and pay already earned for a pay period prior to an employer's designated pay day.

27. The method of claim 23, wherein the employee's request for payroll access is transmitted by a communications means selected from the group consisting of: internet, facsimile, E-mail, and telephone.

28. The method of claim 23, wherein said request is authenticated using an authentication means selected from the group consisting of: personal identification number, a biometric identification, a password, an electronic key, a signature verification, and a photo identification.

29. The method of claim 23, wherein the payroll access is provided through a payroll access resource.

30. The method of claim 29, wherein the payroll access resource is a bank account connected via a computer network to the automated teller machine.

31. The method of claim 29, wherein the payroll access resource is an account owned by a party selected from the group consisting of: an employee, an employer, a payroll service, a payroll advance company, a wire transfer company, a bank, a credit union, a third party financial institution, and a credit card company.

32. The method of claim 23, wherein the funds are forwarded to the employee by means of extended credit.

33. The method of claim 23, wherein the funds are forwarded to the employee by means of pre-charged payroll card.

34. The method of claim 23, wherein the funds made accessible are limited to a predetermined amount based upon factors selected from the group consisting of: relative risk of non-payment, amount of transaction fees, employment history of the employee, number of hours worked for a given pay period, probable hours worked for a given pay period, funds withheld in advance, and number of requests by the employee.

35. The method of claim 23, wherein said transaction fee is based upon a factor selected from the group consisting of: a percentage of the amount requested, an annual membership fee, a flat fee, a monthly service fee, and a given fee for a certain number of requests for a given time period.

36. The method of claim 23, wherein the employee pays in advance for a predetermined number of payroll access transactions.

37. A method of providing payroll access comprising the steps of:
receiving a request from an employee for access to the employee's payroll;
forwarding funds to the employee according to said request;
deducting forwarded funds and a transaction fee from the employee's payroll; and
distributing an adjusted pay to the employee at the end of a pay period.

38. The method of claim 37, wherein payroll access is provided on demand.

39. The method of claim 37, wherein payroll access is provided by means of an automatic teller machine.

40. The method of claim 37, wherein the employee can access wages and pay already earned for a pay period.

41. The method of claim 37, wherein the employee can access payroll prior to an employer's designated payday.

42. The method of claim 37, wherein the employee's request for payroll access is transmitted by a means selected from the group consisting of: web portal, facsimile, E-mail, and telephone.

43. The method of claim 37, wherein said request is authenticated using an authentication means selected from the group consisting of: personal identification number, biometric identification, password, electronic key, signature verification, and photo identification.

44. The method of claim 37, wherein the amount transferred to the employee is deducted from the several employee paychecks over a period of time.

45. The method of claim 37, wherein the payroll access is provided through a payroll access resource.

46. The method of claim 45, wherein the payroll access resource is a financial resource selected from the group consisting of: a bank account, a credit account, a secondary payroll access account, a shared account, a trust account, a temporary account, a savings account, and a checking account.

47. The method of claim 45, wherein the payroll access resource is an account owned by a party selected from the group consisting of: an employee, an employer, a payroll service, a payroll advance company, a wire transfer company, a bank, a credit union, a third party financial institution, and a credit card company.

48. The method of claim 37, wherein the adjusted pay is distributed to the employee by a means selected from the group consisting of: electronic transfer, certified check, automated teller machine, wire transfer, extended credit, pre-charged payroll card, and electronic credits.

49. The method of claim 37, wherein the funds made accessible are limited to a predetermined amount based upon factors selected from the group consisting of: relative risk of non-payment, amount of transaction fees, employment history of the employee, number of hours worked for a given pay period, probable hours worked for a given pay period, funds withheld in advance, and a certain number of requests by the employee.

50. The method of claim 37, wherein said transaction fee is based upon a factor selected from the group consisting of: a percentage of the amount requested, is based on an annual membership fees, a flat fee, is a monthly service fee, and is based upon the number of requests for a given time period.

51. The method of claim 37, wherein the employee pays for a certain number of payroll access transactions.

52. The method of claim 37, wherein information regarding the adjusted pay is transmitted electronically to the employee.

53. The method of claim 52, wherein the information is transmitted over the internet.

54. The method of claim 53, wherein the information is posted on a secure web page.

55. The method of claim 54, wherein the employee can grant secure access to the information to other parties.

56. A method of payroll access comprising the steps of:
providing an employee access to a payroll access account;
accepting a request from an employee for access to the payroll access account;
transferring funds from the payroll access account to the employee per the employee's request;
notifying the employee's payroll service company of the forwarded funds; and
receiving a transaction fee deducted form the employee's payroll.

57. The method of claim 56, wherein access to the payroll access account is provided on demand.

58. The method of claim 56, wherein access to the payroll access account is provided by means of an automatic teller machine.

59. The method of claim 56, wherein the employee can access wages not yet earned for a pay period through the payroll access account.

60. The method of claim 56, wherein the employee's request for payroll access is transmitted by a means selected from the group consisting of: web portal, facsimile, E-mail, and telephone.

61. The method of claim 56, wherein said request is authenticated using an authentication means selected from the group consisting of: personal identification number, biometric identification, password, electronic key, signature verification, and photo identification.

62. The method of claim 56, wherein the amount deducted from the employee's payroll is deducted from wages of a single pay period.

63. The method of claim 56, wherein the payroll access account is a financial resource selected from the group consisting of: a bank account, a credit account, a secondary payroll access account, a shared account, a trust account, a temporary account, a savings account, and a checking account.

64. The method of claim 56, wherein the payroll access account is owned by a party selected from the group consisting of: an employee, an employer, a payroll service, a payroll advance company, a wire transfer company, a bank, a credit union, a third party financial institution, and a credit card company.

65. The method of claim 56, wherein the funds are transferred to the employee by a means selected from the group consisting of: electronic transfer, certified check, automated teller machine, wire transfer, extended credit, pre-charged payroll card, and electronic credits.

66. The method of claim 56, wherein the funds made accessible are limited to a predetermined amount based upon factors selected from the group consisting of: relative risk of non-payment, amount of transaction fees, employment history of the employee, number of hours worked for a given pay period, probable hours worked for a given pay period, funds withheld in advance, and number of requests by the employee.

67. The method of claim 56, wherein said transaction fee is based upon a factor selected from the group consisting of: a percentage of the amount requested, an annual membership fee, a flat fee, a monthly service fee, and a number of requests for a given time period.

68. The method of claim 56, wherein the employee pays for a certain number of payroll access transactions.

69. A method of payroll access comprising the steps of:
providing an employee access to a payroll access credit card account;
accepting a request from an employee for access to the payroll access credit card account;
transferring funds form the payroll access credit card account to the employee per the employee's request;
notifying the employee's payroll service company of the forwarded funds, and
receiving a transaction fee deducted form the employee's payroll.

70. The method of claim 69, wherein payroll access is provided on demand.

71. The method of claim 69, wherein payroll access is provided by means of an automatic teller machine.

72. The method of claim 69, wherein the employee can access wages not yet earned for a pay period.

73. The method of claim 69, wherein the employee's request for payroll access is transmitted by a means of a computer network.

74. The method of claim 69, wherein said request is authenticated using an authentication means selected from the group consisting of: a personal identification number, a biometric identification, a password, an electronic key, a signature verification, and a photo identification.

75. The method of claim 69, wherein the amount transferred to the employee is deducted from the several employee paychecks over a period of time.

76. The method of claim 69, wherein the funds are forwarded to the employee by means of a line of extended credit.

77. The method of claim 69, wherein the funds made accessible are limited to a predetermined amount above based upon an employee's existing line of credit.

78. The method of claim 69, wherein said transaction fee is based upon a factor selected from the group consisting of: a percentage of the amount requested, an annual membership fees, a flat fee, a monthly service fee, and a certain number of requests for a given time period.

79. A method of payroll access comprising the steps of:
providing an employee access to a payroll access account serviced by a bank,
authorizing an employee to request and withdraw funds from said payroll access account using bank services,
receiving information regarding account transactions for said payroll access account;
notifying a payroll service of the employee's of funds withdrawn from the payroll access account; and
receiving a transaction fee deducted form the employee's paycheck by the payroll service company.

80. The method of claim 79, wherein payroll access is provided by means of an automatic teller machine.

81. The method of claim 79, wherein the employee can access wages already earned for a pay period.

82. The method of claim 79, wherein said request is authenticated using an authentication means selected from the group consisting of: a personal identification number, a biometric identification, a password, an electronic key, a signature verification, and a photo identification.

83. The method of claim 79, wherein the funds are forwarded to the employee by a means selected from the group consisting of: electronic transfer, negotiable instrument, automated teller machine, wire transfer, extended credit, pre-charged payroll card, and electronic credits.

84. The method of claim 79, wherein the funds made accessible are limited to a predetermined amount based upon factors selected from the group consisting of: relative risk of non-payment, amount of transaction fees, employment history of the employee, number of hours worked for a given pay period, probable hours worked for a given pay period, funds withheld in advance, and a certain number of requests by the employee.

85. The method of claim 79, wherein said transaction fee is based upon a factor selected from the group consisting of: a percentage of the amount requested, an annual membership fee, a flat fee, a monthly service fee, a certain number of requests for a given time period.

86. A method of payroll access comprising the steps of:
receiving a wire transfer request from an employee;
wire transferring funds to an employee;
notifying an employee's payroll service company of the wire fee; and
receiving reimbursement for the wired funds and an additional fee deducted form an employee's payroll.

87. A method of payroll access comprising the steps of:
providing a payroll service company with information regarding an employee to whom payroll access is given;
determining a limit on the amount of funds that can be accessed by the employee;
issuing the employee a payroll access ATM card;
receiving requests for payroll access when the employee uses the ATM card to request funds;
forwarding the requested funds to the employee;
receiving notification from the ATM via a computer network of the transaction;
forwarding the amount of the funds withdrawn together with fees to a payroll service company of the employee, adjusting the balance on the limit on the ATM card according to the amount withdrawn by the employee;
receiving reimbursement for the forwarded funds and payment for transaction fee and other fees, all being deducted frm employee's paycheck; and
resetting the limit on the ATM card.

88. The method of claim 87, wherein the employee's request for payroll access is transmitted by a means selected from the group consisting of: the internet, facsimile, E-mail, and telephone.

89. The method of claim 87, wherein said request is authenticated using a authentication means selected from the group consisting of: a personal identification number, a biometric identification, a password, an electronic key, a signature verification, and a photo identification.

90. The method of claim 87, wherein the amount deducted from the employee's payroll is deducted from wages of a single pay period.

91. The method of claim 87, wherein the funds are forwarded to the employee by a means selected from the group consisting of: electronic transfer, certified check, automated teller machine, wire transfer, extended credit, pre-charged payroll card, and electronic credits.

92. A method of providing payroll access comprising the steps of:
providing an employee access to a payroll access account tied to an ATM card,
determining a limit on the funds that the employee can withdraw from said payroll access account for a given pay period,
issuing a payroll access ATM card to said employee,
receiving a request from the employee through an ATM for access to funds in a payroll access account,
transferring funds to an authenticated user through said ATM;
receiving notification from the ATM of the transfer of funds,
calculating fees for the transaction,
notifying a payroll service company of the employee to deduct an amount equal to the funds transferred and the fees from the employee's payroll,
receiving the amount deducted from the employee's payroll check and the fees.

93. An apparatus for employee payroll access on demand comprising:
means for receiving a request from the employee for payroll access;
means for forwarding funds to the employee on demand; and
means for deducting the forwarded funds from the employee's payroll check.
